(19) United States
(12) Patent Application Publication
(10) Pub. No.: US 2024/0350988 A1
(43) Pub. Date: Oct. 24, 2024

(54) A SYSTEM AND METHOD FOR GENERATING NANOBUBBLES

(71) Applicant: RAINFOREST ALGAE CORP., Calgary (CA)

(72) Inventors: Stanley PANKRATZ, Calgary (CA); Peter KUSALIK, Calgary (CA)

(21) Appl. No.: 18/686,101

(22) PCT Filed: Aug. 23, 2022
(86) PCT No.: PCT/CA2022/051277

§ 371 Date: Feb. 23, 2024

Related U.S. Application Data
(60) Provisional application No. 63/236,152, filed on Aug. 23, 2021.

(51) Int. Cl. B01F 23/2375; B01F 23/23; B01F 23/234

(52) U.S. Cl. CPC B01F 23/2375; B01F 23/2342; B01F 23/238

(57) ABSTRACT

The present invention provides a system and a method for generating nanobubbles in a liquid medium, which involves one or more movable members, each having a surface and configured to periodically expose at least a portion of the surface to the gaseous medium and the liquid medium to form a wetted surface, thereby generating a renewing wetted surface for enhancing mass transfer of the gas between the liquid medium and gaseous medium; and means for generating an electric field in the proximity of the renewing wetted surface for the generation of nanobubbles without electrolysis of the liquid medium.

### FIELD

The present invention relates generally to generating nanobubbles. In particular, the present disclosure relates to an improved system and method for generating nanobubbles efficiently.

### BACKGROUND

In recent years, nanobubble technologies have drawn widespread attention due to their wide-ranging applications in many industries, for example, health care, agriculture, aquaculture, water treatment, and the medical industry. Nanobubbles offer a high surface area: volume ratio and hence have found applications such as surface cleaning, wastewater treatment by floatation and in bio-gas applications including controlling methane emissions from agriculture. Their interesting properties have stimulated considerable research, including methods of generating them.

Several alternative approaches have been used to generate nanobubbles. Some processes rely on cavitation, wherein sudden changes in pressure may cause the generation of bubbles, or intense mechanical agitation. Such approaches require a relatively large amount of energy and specialized physical apparatus to form the nanobubbles.

Another approach is to force a gas at high pressure through a porous wall/permeable membrane, and thus creating nanobubbles on its outer surface, which is in contact with the liquid. Other technologies rely on electrolysis requiring direct water and electrode contact to split water into oxygen and hydrogen wherein the produced gases form nanobubbles. Given the rather large energy costs associated with electrolysis such technologies are highly inefficient energetically (i.e., in comparison to the reversible work required for the generation of the nanobubbles).

PCT Publication Nos. WO2020079020 and W2021/073780A1 by Niall Joseph English and Mohammad Reza Ghaani, disclose a system and method, which injects gas into a liquid and relies on the generation of an electric field within the liquid using pairs of electrodes in the proximity of the liquid to facilitate the nucleation/generation of nanobubbles with the gas.

Most existing approaches are limited in the number of nanobubbles being produced in solution, where typically the nanobubbles represent only about 0.0001% by volume.

Therefore, there remains a need for a cost effective system and method for generating nanobubbles, which can increase the amount of the gas in the liquid, and/or increase the rate of transfer/exchange of the gas.

### SUMMARY OF THE INVENTION

The present invention relates to a system and method of generating nanobubbles.

In accordance with an aspect of the present invention, there is provided a system for generating nanobubbles in a liquid medium in a reservoir. The system comprises means to provide a gaseous medium in contact with the liquid medium; one or more movable members, each having a surface, the one or more members configured to periodically expose at least a portion of said surface to the gaseous medium and the liquid medium to form a wetted surface, thereby generating a renewing wetted surface for enhancing mass transfer of the gas between the liquid medium and gaseous medium and gaseous medium, and means for generating an electric field in the proximity of the renewing wetted surface for the generation of nanobubbles without electrolysis of the liquid medium.

In accordance with another aspect of the present invention, there is provided a method of producing nanobubbles within a liquid medium. The method comprises providing the liquid medium and a gaseous medium in contact with a surface of one or more movable members configured to periodically expose at least a portion of the surface to the gaseous medium and the liquid medium; exposing the surface of the one or more movable members periodically to the gaseous medium and the liquid medium to form a renewing wetted surface; and generating an electric field in the proximity of the renewing wetted surface to produce the nanobubbles in the liquid medium.

### BRIEF DESCRIPTION OF THE FIGURES

Further features and advantages of the present improvements/invention will become apparent from the following detailed description, taken in combination with the appended figures, in which:

FIG. 1 is a schematic partial view of a system in accordance with an embodiment of the present invention.

FIG. 2 is a schematic partial view of a system in accordance with another embodiment of the present invention.

FIG. 3 is a schematic partial view of a system in accordance with another embodiment of the present invention.

FIG. 4 is a schematic partial view of a system in accordance with another embodiment of the present invention.

### DETAILED DESCRIPTION

Unless defined otherwise, all technical and scientific terms used herein have the same meaning as commonly understood by one of ordinary skill in the art to which this invention belongs.

Unless the context requires otherwise, throughout this specification and claims, the words “comprise”, “comprising” and the like are to be construed in an open, inclusive sense. The words “a”, “an”, and the like are to be considered as meaning at least one and not limited to just one.

The term “nanobubbles” as used herein refers to ultra-fine bubbles, nanopores and/or nanostructures, which have diameters/sizes of less than 10-6 m.

As used herein, the term “about” refers to approximately a +/−10% variation from a given value. It is to be understood that such a variation is always included in any given value provided herein, whether or not it is specifically referred to.

The present invention provides an improved method and system for generating microbubbles by using electric field, wherein the effective contact area between the liquid and the gas, and mixing in the multi-phase system are improved, thereby reducing or eliminating the need for injection or infusion of the gas into the liquid.

The present application has established that by providing a movable member having a surface configured to be periodically/alternately exposed to the gaseous medium, the liquid medium forms a renewing wetted surface outside the liquid medium, which provides a larger, more effective relative surface area (beyond the stationary gas-liquid interface), to achieve greater gas exchange/transfer between the liquid and gaseous mediums.

The system and method of the present invention achieve a more effective exchange/transfer of the gas into the liquid media by effectively bypassing the slow diffusional processes of the bulk liquid phase. By briefly exposing the renewing wetted surface directly to the gas phase, the surface can readily become saturated with gas, thereby ensuring that gas species are more readily available for nanobubble generation. In this way the transfer/exchange of the gases into the liquid phase are effectively enhanced. The movement/rotation of the movable surface further enhances the entrainment of gas into the liquid medium and the dispersal of the nanobubbles in solution.

The method of the present invention requires a small fraction of the energy that would be associated with any technology utilizing electrolysis, cavitation or mechanical means to achieve a similar outcome.

The system and method of the present invention can be easily installed and implemented within the existing infrastructure.

The system and method of the present invention can achieve enhanced nanobubbles generation without the need for sparging and the passing of finely dispersed gas bubbles through a liquid.

In one aspect, the present invention provides a system for generating nanobubbles in a liquid medium in a reservoir. The system comprises a means to provide a gaseous medium in contact with the liquid medium; one or more movable members, each having a surface, wherein one or more movable members are configured to periodically/alternately expose the surface thereof, to the gaseous medium and the liquid medium to form a wetted surface, thereby generating a renewing wetted surface for enhancing mass transfer of the gas between the liquid medium and gaseous medium; and means for generating an electric field in the proximity of the renewing wetted surface for the generation of nanobubbles without electrolysis of the liquid medium.

The reservoir can be a container, receptacle or a body of water, such as such as pond, lake, channel, stream, etc.).

The one or more movable members can be rotatable members having a central axis, and configured to rotate about the central axis, or one or more movable tracks.

Non-limiting examples of a rotatable member include a closable/sealable container, a cylinder, a shaft, an auger, etc. Non-limiting example of movable track includes conveyor belts.

The central axis of the rotatable member is oriented at an angle from 0° to 90° relative to horizontal. In some embodiments, the central axis of the rotatable member is oriented at an angle between 0° to 90° relative to horizontal. In some embodiments, the central axis of the rotatable member is oriented at an angle between 0° to 75° relative to horizontal.

In some embodiments, the reservoir is a closable/sealable container, provided with inlet(s) for the gaseous and liquid medium and outlet for the reaction products, wherein the container itself is rotatable on its central axis, and the renewing wetted surface is the interior surface of the container. The container can have any shape such as cylindrical, elliptical, round, square, rectangular, etc. (preferably cylindrical).

In some embodiments, the reservoir is a receptacle, wherein the rotatable member is configured to be positioned in the receptacle, and the renewing wetted surface is an outer and/or inner surface of the rotatable member. The receptacle can be closable receptacle, such as a closable container, or an open receptacle, such as trough.

The liquid medium can comprise aqueous and/or non-aqueous liquids, for example water, hydrocarbons, etc. The liquid medium can comprise one liquid or a mixture of two or more liquids. The gaseous medium can comprise one gas or a mixture of two or more gases.

In some embodiments, the reservoir is a body of water (such as pond, lake, channel, stream, etc.) wherein the rotatable member is configured to be positioned in the reservoir, and the wetted surface is an outer and/or inner surface of the rotatable member.

In some embodiments, the shaft further comprises one or more discs (optionally rotatable) mounted on the shaft.

In some embodiments, the movable member is a movable track (such as, a conveyor belt) configured to move in and out of the liquid medium.

In some embodiments, the closable container of present invention further comprises a secondary rotatable member, preferably having a rotating axis coaxial with the central axis of the container, wherein a surface of the secondary rotatable member is also exposed periodically/alternately to the gaseous medium and the liquid medium upon rotation of the rotatable member.

In some embodiments, the secondary rotatable member is a cylinder, an auger or a shaft optionally comprising one or more discs (optionally rotatable) mounted thereon. At least the outer surface of the secondary rotatable member provides additional surface area upon which “liquid” wetting may occur, thus providing additional surface area upon which gas transfer may take place between the gaseous and the liquid media, and potentially aid in mixing.

In some embodiments, the secondary rotatable member comprises at least one additional closable/sealable container placed inside the rotatable container, optionally provided with the liquid medium and the gaseous medium. Preferably, the additional container has a rotating axis coaxial with the central axis of the container. In such embodiments, the inner and outer surfaces of the additional container provide additional surfaces upon which “liquid” wetting may occur, thereby further enhancing the gas mass transfer.

In some embodiments, the surfaces upon which the electric fields are generated are periodically/alternately immersed in the liquid and then that wetted surface is moved out of the liquid and exposed to the gas (e.g. dipping).

In some embodiments, the means for generating an electric field comprises one or more insulated conductors (insulated electrodes) in electrical communication with an electricity source that can be placed on or near the surface configured to be periodically/alternately exposed to the gaseous medium and the liquid medium.

In some embodiments, the insulated conductors are incorporated into the surface of the movable member.

In some embodiments, the insulated conductors are provided at least on the outer surface of a rotating member, configured to be placed inside a closable/sealable container, in a receptacle, or in a water body.

In some embodiments, when the rotatable member is a closable/sealable container for containing the liquid medium and gaseous medium, the insulated conductors are placed inside the container (preferably in contact with the interior surface of the container).

In some embodiments, the system comprises at least one pair of insulated conductors that are spaced apart, wherein one conductor of the pair is positive and the other conductor of the pair is negative, or one conductor of the pair is positive or negative and the other is ground.

In some embodiments, the insulated conductors are insulated wires arranged in a parallel configuration, a grid configuration (such as crisscross grid or two grids separated by a gap) or a mesh configuration. In some embodiments, the conductors are conducting plates.

The insulation for the conductors can be achieved via covering the conductors with electrically insulating material or coating.

In some embodiments, the one or more rotatable members comprise at least one pair of alternatively/oppositely charged rotatable insulted conducting discs in electrical communication with an electricity source.

In some embodiments, the one or more rotatable members comprise one or more rotatable discs with a pair of electrical conductors attached to a surface of the discs.

In some embodiments, the surfaces involved in the formation of formation of renewing wetted surface, in the generation of the electric field and/or the generation of nanobubbles may be altered in ways that may enhance the creation of nanobubbles. Such surfaces may be smooth, hydrophilic, hydrophobic, rough, corrugated, coated for example with nanoparticles, otherwise textured, etc.

In some embodiments, wherein the electricity source is DC or AC of a selected voltage. In some embodiments, the voltage is obtained via direct electrical connection. In some embodiments, the voltage is induced.

In some embodiments, the system further comprises a signal generator connected to the electricity source to create a modulated electrical signal through the electrical conductors to affect a modulated electric field which in turn may influence the generation of nanobubbles.

The rotation of the rotatable member can be achieved directly or indirectly via a motor or one or more drive mechanisms known in the art. In some embodiments, the system comprises means/regulators for adjusting the speed of the movable member. Different gases will have differing solubility within the liquid medium and differing surface adsorption behaviors. Changing the speed of the moving surfaces may impact the rate at which the gas is transferred between the liquid and gas phases and the rate of mixing within the solution.

In some embodiments, the system comprises a temperature sensor (e.g. a thermocouple for sensing temperature in the gaseous and liquid phases. In some embodiments, the system comprises a pressure sensor for sensing pressure in the gaseous and liquid phases.

In some embodiments, the system further comprises regulators for adjusting temperature and/or pressure in the gaseous and liquid phases.

The system comprises means to supply liquid and/or gaseous medium to the reservoir. In some embodiments, the gaseous medium is provided above the upper surface of the liquid medium.

In another aspect, the present invention provides a method of producing nanobubbles within a liquid medium. The method comprises providing the liquid medium and a gaseous medium in contact with a surface of one or more movable members configured to periodically/alternately expose at least a portion of the surface to the gaseous medium and the liquid medium, exposing the movable surface of the one or more movable members periodically/alternately to the gaseous medium and the liquid medium to form a renewing wetted surface, and generating an electric field in the proximity of the renewing wetted surface to produce the nanobubbles in the liquid medium.

The one or more movable members can be rotatable members having a central axis, and configured to rotate about the central axis, or one or more movable tracks, such as conveyor belts, as discussed above.

In some embodiments, the movable member is a closable/sealable container configured to rotate about the central axis thereof, and the method comprises providing the liquid medium and the gaseous medium in the closable/sealable container, wherein the renewing wetted surface is the interior surface of the container that is exposed periodically/alternately to the gaseous medium and the liquid medium upon rotation of the container.

In some embodiments, the movable member is a rotatable member configured to rotate about the central axis thereof, and the method comprises providing the liquid medium in a receptacle comprising the movable member, wherein the renewing wetted surface is at least the outer surface of the rotatable member that is exposed periodically/alternately to the gaseous medium and the liquid medium upon rotation of the rotatable member.

In some embodiments, the reservoir is a body of water (such as pond, lake, channel, stream, etc.), and the movable member is a rotatable member configured to rotate about the central axis thereof, and the method comprises providing the rotatable member in contact with water, wherein the renewing wetted surface is at least the outer surface of the rotatable member that is exposed periodically/alternately to the gaseous medium and the liquid medium upon rotation of the rotatable member.

In some embodiments, the movable member is a moving track, and the method comprises providing the liquid medium in a receptacle comprising the movable member, wherein the renewing wetted surface is the surface of the track that is exposed periodically/alternately to the gaseous medium and the liquid medium upon rotation of the rotatable member.

In some embodiments, the reservoir is a body of water (such as pond, lake, channel, stream, etc.), the movable member is a moving track, and the method comprises providing the movable track in contact with water, wherein the renewing wetted surface is the surface of the track that is exposed periodically/alternately to the gaseous medium and the liquid medium.

In some embodiments, the one or more rotatable members comprise at least one pair of oppositely charged insulated conducting discs, and the method comprises providing the liquid medium in a receptacle comprising the charged insulated rotatable discs.

In some embodiments, the one or more rotatable members comprise one or more rotatable discs with a pairs of insulated conductors attached to a surface of the discs, and the method comprises providing the liquid medium in a receptacle comprising the rotatable discs.

The system and method of the present system can be used in any chemical, biological, or engineering process relying on the presence or storage of gas in solution or the mass transfer of gas between liquid and gas phases which may be improved by the addition of nanobubbles.

The energy efficient generation of nanobubbles has utility in many biological, chemical, or engineering processes, where mass transfer of gases plays an important role. For example, there are applications in water, and waste-water treatments, the treatment of ponds and lakes for pest control. Nanobubbles, when present in a sufficient concentration may affect a change in physical properties such as density, viscosity and rheology of a liquid phase. Nanobubbles may enable enhancing of the growth of water-based plants, in promoting metabolism and living organisms. Nanobubbles may be used to direct mass transport using principles of (di) electrophoresis or acoustophoresis. Nanobubbles may enable settling of particulates within a liquid phase (by reducing the liquid density). They may also be used in certain instances for creating buoyancy of particles so that they will tend to float to the surface of the liquid. They can also be used for cleaning fabrics. Nanobubbles may be used for drug delivery for medical purposes and may be used to produce hyper-oxygenated solutions.

In some embodiments, the system of the present invention is for cultivation of microorganisms (such as microalgae, yeast, etc.). In such embodiments, the liquid medium is provided with a microorganism culture and nutrients.

To gain a better understanding of the invention described herein, the following example is set forth. It will be understood that this example is intended to describe an illustrative embodiment of the invention and is not intended to limit the scope of the invention in any way.

### Examples

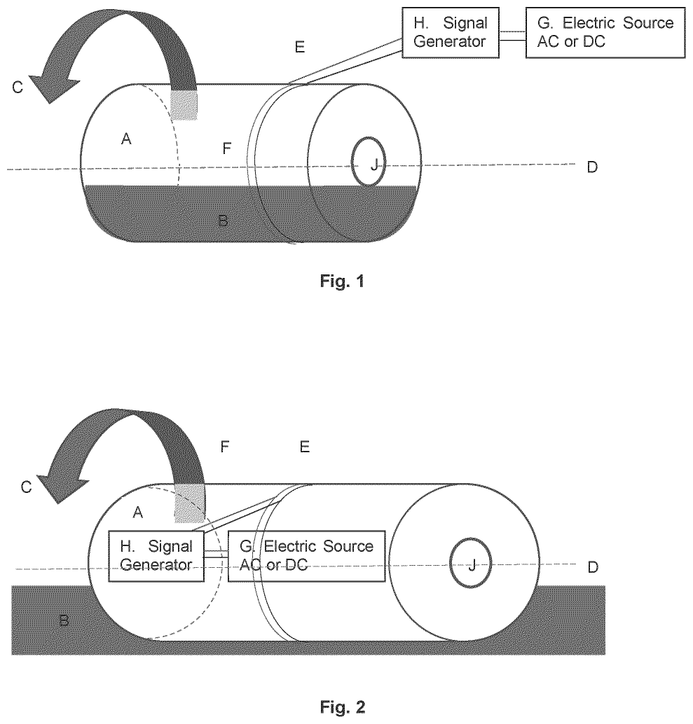

FIG. 1 schematically illustrates an example of the system of the present invention for generating nanobubbles, which comprises a rotatable cylindrical container A, partially filled with a liquid B, and provided with gas F above the liquid. The container has a central axis D, and configured to rotate about its horizontal axis D in direction C via a drive mechanism (not shown) so that the interior surface of the container is periodically/alternatingly immersed in the liquid and then the wetted surface is exposed to the gas. The container can have input of liquid and of gas through closable/sealable opening J, as well as output of reaction products through same opening J.

There are pairs of insulated electrical conductors E attached to the inside surface of cylindrical container, where the conductors are laid out in a parallel and concentric pattern with a separation between the pair of conductors. Each of the conductors of a pair is connected to an applied external voltage source G (AC or DC), where one conductor is identified as positive and the other as negative to produce an electric field between conductors. Conductors of opposite voltage have no electrical contact with the other (i.e. it is an open circuit), nor with the liquid phase (i.e. the conductors are insulated). A signal/voltage generator H can provide a voltage with a particular waveform and frequency.

As a use-case example, in the cultivation of a micro-organism i.e. algae, the inlet J would be for the delivery of nutrient media to be introduced to a growing algae culture after the nutrient media has been treated to create nanobubbles within the media to effect enhanced growth of the algae. Ambient air and/or CO₂, and nutrient media for the cultivation of the algae would be introduced through an opening J. Once present the nanobubbles generator would be rotated along with the electric field being applied by turning on the electric source G. Through the same opening J, gas and treated nutrient media may be removed.

FIG. 2. Schematically illustrates an example of the system of the present invention for generating nanobubbles, which comprises a rotatable cylinder or cylindrical container A, partially immersed horizontally in a liquid B, with air or gas phase F above the liquid. The cylinder/cylindrical container has a central axis D, and configured to rotate about its horizontal axis in direction C via a drive mechanism (not shown) so that the exterior surface of the container is alternatingly immersed in the liquid and then the wetted surface is exposed to the gas phase F.

At least a pair of insulated electrical conductors E are attached to the outside surface of the cylinder, where the conductors are laid out in a parallel and concentric pattern with a separation between the pair of conductors. Each of the conductors of the pair is connected to an applied external voltage source G (AC or DC), where one conductor is identified as positive and the other as negative to produce an electric field between conductors. Conductors of opposite voltage have no electrical contact with the other (i.e. it is an open circuit), nor with the liquid phase (i.e. the conductors are insulated). A signal/voltage generator H can provide a voltage with a particular waveform and frequency. The electric source G and signal generator H may be found inside the cylinder A. Alternatively the applied voltage may be applied to the wire through a rotating slip ring system or through an inductive electric system through an opening J within the cylindrical container along the axis D.

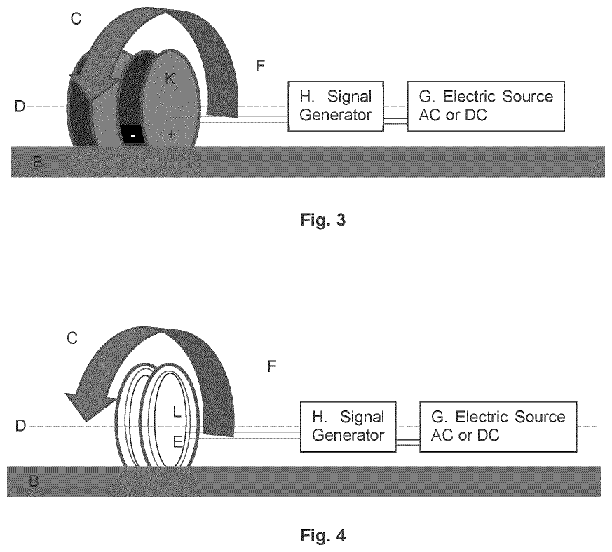

FIG. 3. schematically illustrates an example of the system of present invention for generating nanobubbles, which comprises a rotating set of alternatively/oppositely charged (positive and negative) insulated discs K. The discs K rotate about a horizontal axis in direction C via a drive mechanism (not shown) so that the surfaces of the discs are alternatingly immersed in the liquid and then the gas phase, such that the wetted surfaces are exposed to the air or gas phase above the liquid.

The insulated discs K in one example are oriented to be separated and parallel with each alternately charged disc. Each disc K is connected to an applied external voltage source G (AC of DC) where one disc is identified as positive and a neighboring disc as negative to produce an electric field between neighboring discs.

FIG. 4. Schematically illustrates an example of the system of the present invention for generating nanobubbles, which comprises as a single or set of separated rotating discs L with pairs of electrical conductors E attached to the surface of the discs. The discs L rotate about a horizontal axis in direction C via a drive mechanism (not shown) so that the surfaces of the discs are alternatingly immersed in the liquid and then the gas phase, such that the wetted surfaces are exposed to the air or gas phase above the liquid.

The discs L in one example have insulated electrical conductors E attached to the surface of the discs in parallel and in a concentric pattern with separation between the pair of conductors. Each of the conductors of a pair is connected to an applied external voltage source G (AC or DC), where one conductor is identified as positive and the other as negative to produce an electric field between conductors. Conductors of opposite voltage have no electrical contact with the other (i.e. it is an open circuit), nor with the liquid phase (i.e. the conductors are insulated). A signal/voltage generator H can provide a voltage with a particular waveform and frequency. The electric source G and signal generator H may be found attached to the axis D. Alternatively, the applied voltage may be applied to the wires through a rotating slip ring system or through an inductive electric system transmitted along the axis D.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A system for generating nanobubbles in a liquid medium in a reservoir, the system comprising:
a. means to provide a gaseous medium for contact with the liquid medium;
b. one or more movable members, each having a surface, the one or more members configured to periodically expose at least a portion of said surface to the gaseous medium and the liquid medium to form a wetted surface, thereby generating a renewing wetted surface for enhancing mass transfer of a gas between the liquid medium and gaseous medium; and
c. means for generating an electric field in a proximity of the renewing wetted surface for the generation of nanobubbles without electrolysis of the liquid medium.

2. The system of claim 1, wherein the one or more movable members are rotatable members having a central axis, and configured to rotate about the central axis.

3. The system of claim 2, wherein the reservoir is a sealable container, the sealable container being the rotatable member, wherein the sealable container is further provided with an inlet for the gaseous and liquid medium and an outlet for products of a reaction involving said mass transfer of the gas between the liquid medium and gaseous medium, and the renewing wetted surface is an interior surface of the container, optionally the central axis of the rotatable member is oriented horizontally or at an angle between 0° and 90° relative to horizontal.

4. (canceled)

5. The system of claim 2, wherein the reservoir is a receptacle or a body of water, and wherein the one or more rotatable members are selected from a container, a cylinder, a shaft, and an auger, wherein the renewing wetted surface is an outer surface of the rotatable member, and optionally an inner surface of the rotatable member, optionally the central axis of the rotatable member is oriented horizontally or at an angle between 0° and 90° relative to horizontal.

6. (canceled)

7. (canceled)

8. The system of claim 1, wherein the movable member is a movable track.

9. The system of claim 3, wherein the means for generating the electric field comprises one or more insulated conductors in electrical communication with an electricity source, said conductors being placed inside the container, optionally said conductors are in contact with the interior surface of the container.

10. (canceled)

11. The system of claim 5, wherein the means for generating the electric field comprises one or more insulated conductors in electrical communication with an electricity source, said conductors being placed on or near the renewing wetted surface.

12. The system of claim 5, wherein the system comprises at least one pair of insulated conductors that are spaced apart, wherein one conductor of the pair is positive and the other conductor of the pair is negative, or one conductor of the pair is positive or negative and the other is ground.

13. The system of claim 9, wherein the insulated conductors are insulated wires arranged in a parallel configuration, a grid configuration or a mesh configuration, or the insulated conductors are conducting plates.

14. (canceled)

15. The system of claim 2, wherein the one or more rotatable members comprise at least one pair of rotatable and oppositely charged insulated conducting discs in electrical communication with an electricity source, or one or more rotatable discs with insulated electrical conductors attached to a surface of the discs.

16. (canceled)

17. The system of claim 9, wherein the electricity source is DC or AC of a selected voltage, further comprising a signal generator connected to the electricity source to create a modulated electric signal.

18. (canceled)

19. A method of producing nanobubbles within a liquid medium, the method comprising:
a. providing the liquid medium and a gaseous medium in contact with a surface of one or more movable members configured to periodically expose at least a portion of said surface to the gaseous medium and the liquid medium;
b. exposing said surface of the one or more movable members periodically to the gaseous medium and the liquid medium to form a renewing wetted surface; and
c. generating an electric field in a proximity of the renewing wetted surface to produce the nanobubbles in the liquid medium.

20. The method of claim 19, wherein the movable member is a rotatable member having a central axis, the rotatable member being configured to rotate about the central axis.

21. The method of claim 20, wherein the rotatable member is a sealable container configured to rotate about the central axis thereof, and the method comprises providing the liquid medium and the gaseous medium in the sealable container, wherein the renewing wetted surface is an interior surface of the container that is exposed periodically to the gaseous medium and the liquid medium upon rotation of the container.

22. The method of claim 21, wherein the electric field is generated by providing one or more insulated conductors in electrical communication with an electricity source and placing said insulated conductors inside the container, or said conductors are in contact with the interior surface of the container.

23. (canceled)

24. The method of claim 20, wherein the method comprises providing the liquid medium in a receptacle comprising the rotatable member or the liquid medium is a body of water and the method comprises providing the rotatable member in contact with water, wherein the renewing wetted surface is at least an outer surface of the rotatable member that is exposed periodically/alternately to the gaseous medium and the liquid medium upon rotation of the rotatable member.

25. (canceled)

26. The method of claim 24, wherein the rotatable member is a container, a cylinder, a shaft, or an auger, and wherein the electric field is generated by providing one or more insulated conductors in electrical communication with an electricity source and placing said one or more insulated conductors on or near the renewing wetted surface.

27. (canceled)

28. The method of claim 20, wherein the one or more rotatable members comprise; at least one pair of oppositely charged insulated discs, and the method comprises providing the liquid medium in a receptacle comprising the rotatable discs, or one or more rotatable discs with a pair of insulated electrical conductors attached to a surface of the discs, and the method comprises providing the liquid medium in a receptacle comprising the rotatable discs.

29. (canceled)

30. The method of claim 19, wherein the movable member is a moving track, and the method comprises providing the liquid medium in a receptacle comprising the moving track, wherein the renewing wetted surface is formed on the surface of the moving track that is exposed periodically to the gaseous medium and the liquid medium, wherein the electric field is generated by providing one or more insulated conductors in electrical communication with an electricity source, and placing said one or more insulated conductors on or near the renewing wetted surface.

31. The method of claim 19, wherein the liquid medium is a body of water, wherein the movable member is a moving track, and the method comprises providing the movable member in contact with water, wherein the renewing wetted surface is formed on the surface of the track that is exposed periodically to the gaseous medium and the liquid medium, wherein the electric field is generated by providing one or more insulated conductors in electrical communication with an electricity source, and placing said one or more insulated conductors on or near the renewing wetted surface.

32. (canceled)
